(19) United States
(12) Patent Application Publication
(10) Pub. No.: US 2007/0039999 A1
(43) Pub. Date: Feb. 22, 2007

(54) Soldering apparatus and soldering method

(75) Inventor: Back Ki Sung, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/269,749

(22) Filed: Nov. 9, 2005

(30) Foreign Application Priority Data
Aug. 19, 2005 (KR) 2005-76493

(51) Int. Cl. B23K 20/14; B23K 1/00; B23K 35/24

(52) U.S. Cl. 228/43; 228/49.5; 228/47.1; 228/232; 228/233.2

(57) ABSTRACT

A soldering apparatus including a preheating conveyor belt to convey a printed circuit board with electronic components mounted thereon, at least one preheating heater to preheat the printed circuit board conveyed by the preheating conveyor belt, a soldering conveyor belt positioned adjacent to the preheating conveyor belt to convey the printed circuit board preheated by the preheating heater, the soldering conveyor belt being driven at a different driving speed from a driving speed of the preheating conveyor belt, and a soldering unit to solder the electronic components to the printed circuit board conveyed by the soldering conveyor belt.

### CROSS-REFERENCE TO RELATED APPLICATIONS

This application claims the benefit of Korean Patent Application No. 2005-76493, filed on Aug. 19, 2005 in the Korean Intellectual Property Office, the disclosure of which is incorporated herein by reference.

### BACKGROUND OF THE INVENTION

1. Field of the Invention

An aspect of the present invention relates to a surface mounting technology, and, more particularly, to a soldering apparatus and a soldering method to attach electronic components onto a printed circuit board.

2. Description of the Related Art

Surface Mounting Technology (SMT) is a technology to mount electronic components on a printed circuit board by soldering the electronic components onto the printed circuit board (PCB). Since the SMT provides a number of advantages, such as a higher density of the electronic components, usability of both sides, and reduction in area of the PCB, SMT is applied in various applications.

The surface mounting technology comprises a number of processes. Devices used for the respective processes are referred to as Surface Mounting Devices (SMDs), and are arranged in a predetermined sequence to constitute a single SMT line.

As fundamental devices, the SMDs include a loading device to supply printed circuit boards, a mounting device to mount electronic components on each printed circuit board, a soldering device to fix the electronic components to the printed circuit board by soldering, an unloading device to unload the completed printed circuit board, and the like. In addition, the SMDs include a screen printer to print solder cream on the surface of a land of the printed circuit board, an inspector to inspect a printed state of the solder cream, and the like.

Among the SMDs, the soldering devices for a soldering operation include a reflow soldering machine, a wave soldering machine, and the like. The reflow soldering machine is a device to secure the electronic components to the printed circuit board by melting the solder cream printed on the printed circuit board, and the wave soldering machine is a device to secure the electronic components thereto by injecting a liquid solder onto the printed circuit board with the electronic components mounted thereon.

One example of the reflow soldering machine is disclosed in Japanese Patent Laid-open Publication No. 2004-172398, which includes a conveyor belt to convey a printed circuit board with electronic components mounted thereon, and a plurality of heaters positioned above the conveyor belt.

Meanwhile, a Pb—Sn solder alloy is generally used for a conventional soldering process. However, since the conventional Sn—Pb solder alloy has a problem of environmental contamination due to leakage of lead upon disposal of the printed circuit board, there is a tendency to regulate the use of Pb.

Thus, the electronic industry has actively developed an environmentally friendly Pb-free solder which does not contain lead. As for such an environmentally friendly Pb-free solder, a tin-copper (Sn—Cu) based solder alloy, and a tin-silver (Sn—Ag) solder alloy are well known in the art.

However, since the Sn—Cu based solder alloy and the Sn—Ag based solder alloy have a higher melting point than the Pb—Sn solder alloy, it is necessary to heat the solder alloys for a long period of time upon soldering.

Accordingly, when using the soldering apparatus comprising the single conveyor belt as disclosed in Japanese Patent Laid-open Publication No. 2004-172398, it is necessary to increase the length of the conveyor belt which conveys the printed circuit board, and the number of heaters.

### SUMMARY OF THE INVENTION

Accordingly, an aspect of the present invention provides a soldering apparatus and a soldering method, which ensures soldering quality without significantly increasing the number of heaters and a length of a conveyor belt even with a high melting point Pb-free solder.

In accordance an aspect of the present invention, a soldering apparatus comprises: a preheating conveyor belt to convey a printed circuit board with electronic components mounted thereon; at least one preheating heater to preheat the printed circuit board conveyed by the preheating conveyor belt; a soldering conveyor belt positioned adjacent to the preheating conveyor belt to convey the printed circuit board preheated by the preheating heater, the soldering conveyor belt being driven at a different driving speed from a driving speed of the preheating conveyor belt; and a soldering unit to solder the electronic components to the printed circuit board conveyed by the soldering conveyor belt.

The driving speed of the preheating conveyor belt may be slower than the driving speed of the soldering conveyor belt.

The soldering apparatus may further comprise a cooling conveyor belt positioned adjacent to the soldering conveyor belt to convey the printed circuit board soldered by the soldering unit, and the driving speed of the cooling conveyor belt may be slower than the driving speed of the soldering conveyor belt.

The soldering apparatus may further comprise a first motor to drive the preheating conveyor belt, a second motor to drive the soldering conveyor belt, and a third motor to drive the cooling conveyor belt.

The soldering apparatus may further comprise a cooling fan to cool the printed circuit board conveyed by the cooling conveyor belt.

The soldering unit may be at least one soldering heater to melt solder cream interposed between the electronic components and the printed circuit board.

The preheating heater may heat the printed circuit board conveyed on the preheating conveyor belt to a temperature of about 150 to 180° C., and the soldering heater may heat the printed circuit board conveyed on the soldering conveyor belt to a temperature of about 220° C.

The at least one soldering heater may be a plurality of soldering heaters positioned below the soldering conveyor belt, and the at least one preheating heater may be a plurality of preheating heaters positioned below the preheating conveyor belt.

The soldering unit may comprise a solder container to contain a liquid solder, and a nozzle to inject the liquid solder to the printed circuit board with the electronic components mounted thereon.

In accordance with another aspect of the present invention, a soldering method is provided, comprising: preheating a printed circuit board with electronic components mounted thereon while conveying the printed circuit board at a first driving speed; soldering the electronic components to the printed circuit board while conveying the printed circuit board at a second driving speed; and cooling the printed circuit board while conveying the printed circuit board at a third driving speed.

The first driving speed may be slower than the second driving speed, and the third driving speed may be slower than the second driving speed.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a schematic diagram illustrating a soldering apparatus in accordance with an embodiment of the present invention;

FIG. 2 is a graph depicting a temperature profile of a printed circuit board passing through the soldering apparatus shown in FIG. 1; and

FIG. 3 is a schematic diagram illustrating a soldering apparatus in accordance with another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

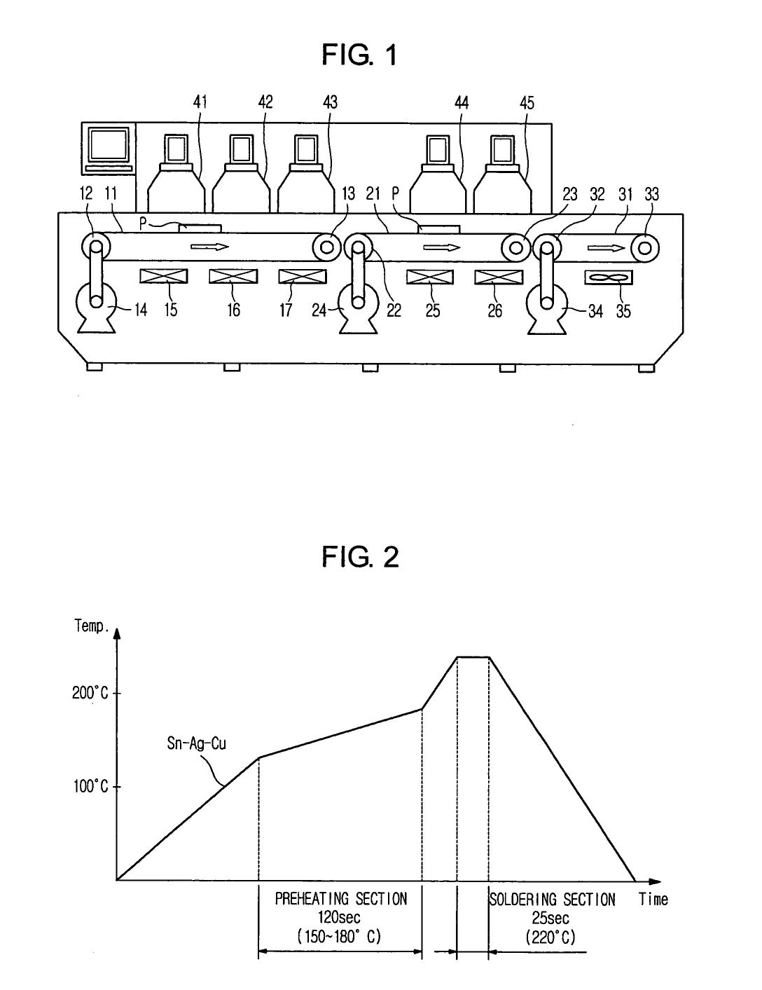

Referring to FIG. 1, the soldering apparatus according to an embodiment is a reflow soldering machine which heats a printed circuit board P to melt solder cream printed on the printed circuit board P, and cures the solder cream. The soldering apparatus shown in FIG. 1 comprises a preheating conveyor belt 11, first, second and third preheating heaters 15, 16 and 17 positioned below the preheating conveyor belt 11, a soldering conveyor belt 21, first and second soldering heaters 25 and 26 positioned below the soldering conveyor belt 21, a cooling conveyor belt 31, and a cooling fan 35 positioned below the cooling conveyor belt 31. A Pb-free solder cream comprising a tin-silver-copper alloy (Sn—Ag—Cu) and having a melting point of about 217° C. is printed on the printed circuit board P.

The preheating conveyor belt 11 is positioned at an inlet, which the printed circuit board P with various electronic components mounted thereon enters, to convey the printed circuit board P. The preheating conveyor belt 11 is drivingly supported by a driving roller 12 and a driven roller 13. The driving roller 12 is driven by a first motor 14, so that the preheating conveyor belt 11 is driven at a first driving speed.

The first, second and third preheating heaters 15, 16 and 17 are positioned below the preheating conveyor belt 11 to heat the printed circuit board P having the electronic components mounted thereon. According to the embodiment illustrated in FIG. 1, the first, second and third preheating heaters 15, 16 and 17 heat the printed circuit board P using hot air. However, various heating manners, for example a heating manner using infrared radiant heat, may be used. The first, second and third preheating heaters 15, 16 and 17 heat the printed circuit board P to a temperature of about 150 to 180° C. while the printed circuit board P is conveyed by the preheating conveyor belt 11. The printed circuit board P is preheated to prevent thermal shock due to rapid increase in temperature of the printed circuit board P to the melting point of the solder cream during soldering as described below.

The printed circuit board P is preheated to a predetermined temperature lower than the melting point of the solder cream for a sufficient period of time before it is conveyed to the first soldering heater 25. As shown in FIG. 2, the printed circuit board P may be heated to a temperature of about 150 to 180° C. for 120 seconds while passing through the first, second and third preheating heaters 15, 16 and 17. A preheating section shown in a temperature profile of FIG. 2 may be secured by adjusting the first driving speed of the preheating conveyor belt 11 to about 600 to 700 mm/min.

The number of preheating heaters does not limit the present invention, and the driving speed of the preheating conveyor belt 11 may be controlled according to the number and performance of the preheating heaters.

First, second and third air dischargers 41, 42 and 43 are positioned above the preheating conveyor belt 11 corresponding to the first, second and third preheating heaters 15, 16 and 17. Each of the first second and third air dischargers 41, 42 and 43 acts to safely discharge detrimental gas generated during heating of the printed circuit board P having the solder cream printed thereon.

The soldering conveyor belt 21 is positioned adjacent to the preheating conveyor belt 11, and conveys the printed circuit board P preheated on the preheating conveyor belt 11. The soldering conveyor belt 21 is coplanar with the preheating conveyor belt 11 in order to prevent a step from being formed on a conveying path of the printed circuit board P. The soldering conveyor belt 21 is drivingly supported by a driving roller 22 and a driven roller 23. The driving roller 22 is driven by a second motor 24. Thus, the soldering conveyor belt 21 is driven at a second driving speed different from the first driving speed of the preheating conveyor belt 11.

The first and second soldering heaters 25 and 26 are positioned below the soldering conveyor belt 21, and heat the printed circuit board P conveyed by the soldering conveyor belt 21 to a higher temperature than the melting point of the soldering cream. Since the melting point of the solder cream comprising the Sn—Ag—Cu alloy is 217° C., the first and second soldering heaters 25 and 26 heat the printed circuit board P to a temperature slightly higher than 217° C.

As shown by the temperature profile of FIG. 2, the first and second soldering heaters 25 and 26 allow the printed circuit board P to be held at a temperature of about 220° C. for about 25 seconds while the printed circuit board P is conveyed by the soldering conveyor belt 21. By holding the printed circuit board P at the temperature slightly above the melting point of the solder cream for a suitable period of time, sufficient wetting of the solder cream is secured when the solder cream is melted, thereby preventing defective soldering.

According to the embodiment shown in FIG. 1, the second driving speed of the soldering conveyor belt 21 is adjusted to about 1,000 to 1,200 mm/min to secure a soldering section shown by the temperature profile of FIG. 2.

According to the embodiment shown in FIG. 2, as with the first, second and third preheating heaters 15, 16 and 17, the first and second soldering heaters 25 and 26 also heat using the hot air. However, various heating manners, for example the heating manner using the infrared radiant heat, may be used. In addition, the number of soldering heaters 25 and 26 may be changed and may vary in number. The driving speed of the soldering conveyor belt 21 may be controlled according to the number and performance of the soldering heaters 25 and 26.

Fourth and fifth air dischargers 44 and 45 are positioned above the soldering conveyor belt 21 corresponding to the first and second soldering heaters 25 and 26. Each of the air dischargers 44 and 45 acts to safely discharge detrimental gas generated during soldering of the printed circuit board P.

The cooling conveyor belt 31 is positioned adjacent to the soldering conveyor belt 21, and conveys the printed circuit board P soldered on the soldering conveyor belt 21. The cooling conveyor belt 31 is coplanar with the preheating conveyor belt 11 and the soldering conveyor belt 21. The cooling conveyor belt 31 is drivingly supported by a driving roller 32 and a driven roller 33. The driving roller 32 is driven by a third motor 34. The cooling conveyor belt 31 is driven at a third driving speed different from the driving speeds of the preheating conveyor belt 11 and the soldering conveyor belt 21.

The cooling fan 35 is positioned below or above the cooling conveyor belt 31, and cools the printed circuit board P conveyed on the cooling conveyor belt 31.

In order to allow the printed circuit board P to be cooled by air flow which is forcibly blown by the cooling fan 35, the third driving speed of the cooling conveyor belt 31 is slower than the second driving speed of the soldering conveyor belt 21.

In the embodiment shown in FIG. 1, since the driving speeds of the preheating conveyor belt 11, the soldering conveyor belt 21, and the cooling conveyor belt 31 are different from each other, the printed circuit boards P must enter the preheating heater 11 while maintaining a suitable distance from each other.

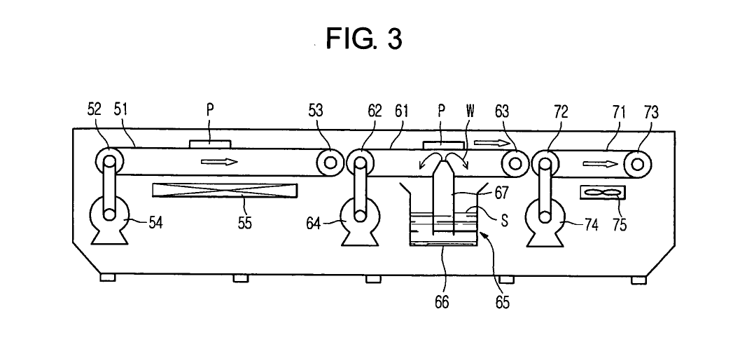

FIG. 3 illustrates a soldering apparatus according to another embodiment of the present invention. The embodiment shown in FIG. 3 is a wave soldering machine, which solders electronic components to a printed circuit board P by spraying liquid solder. The soldering apparatus shown in FIG. 3 comprises a preheating conveyor belt 51, a preheating heater 55 positioned below the preheating conveyor belt 51, a soldering conveyor belt 61 positioned adjacent to the preheating conveyor belt 51, a soldering unit 65 positioned below the soldering conveyor belt 61, a cooling conveyor belt 71 positioned adjacent to the soldering conveyor belt 61, and a cooling fan 75 positioned below the cooling conveyor belt 71. As in the embodiment shown in FIG. 1, a liquid solder used for soldering may be composed of the tin-silver-copper alloy (Sn—Ag—Cu).

The preheating conveyor belt 51 is positioned at an inlet, which the printed circuit board P with electronic components mounted thereon enters. The preheating conveyor belt 51 is drivingly supported by a driving roller 52 and a driven roller 53. The driving roller 52 is driven by a first motor 54.

The preheating heater 55 is positioned below or above the preheating conveyor belt 51, and heats the printed circuit board P conveyed on the preheating conveyor belt 51. According to the embodiment shown in FIG. 3, the preheating heater 55 adopts hot-air heating. However, various heating manners, for example infrared radiant heating, may be used.

The soldering conveyor belt 61 is positioned adjacent to the preheating conveyor belt 51 to convey the printed circuit board P preheated on the preheating conveyor belt 51. The soldering conveyor belt 61 is drivingly supported by a driving roller 62 and a driven roller 63. The driving roller 62 is driven by a second motor 64. Thus, the soldering conveyor belt 61 is driven independently of the preheating conveyor belt 51.

The soldering unit 65 is provided to solder the printed circuit board P conveyed by the soldering conveyor belt 61. The soldering unit 65 comprises a solder container 66 to contain a liquid solder S, and a nozzle 67 to eject the liquid solder S to the printed circuit board P. The nozzle 67 generates a soldering wave W which is ejected towards the printed circuit board P conveyed on the soldering conveyor belt 61 to solder the printed circuit board P.

The cooling conveyor belt 71 is positioned adjacent to the soldering conveyor belt 61 to convey the printed circuit board P soldered on the soldering conveyor belt 61. The cooling conveyor belt 71 is drivingly supported by a driving roller 72 and a driven roller 73. The driving roller 72 is driven by a third motor 74.

The cooling fan 75 is positioned below the cooling conveyor belt 71, and rapidly cools the printed circuit board P conveyed by the cooling conveyor belt 71.

According to the embodiment shown in FIG. 3, the driving speed of the preheating conveyor belt 51 is slower than the driving speed of the soldering conveyor belt 61 in order to allow the printed circuit board P to be sufficiently preheated. In addition, the driving speed of the cooling conveyor belt 71 is slower than the driving speed of the soldering conveyor belt 61 in order to allow the printed circuit board P to be sufficiently cooled after soldering.

In the embodiment shown in FIG. 3, since the driving speeds of the respective conveyor belts 51, 61 and 71 are different from each other, the printed circuit boards P must enter the preheating heater 61 while maintaining a suitable entering distance from each other.

As apparent from the above description, the soldering apparatus according to the present invention divides the conveyor belt into the preheating conveyor belt, the soldering conveyor belt, and the cooling conveyor belt so as to be suitably positioned and controlled in driving speeds corresponding to processes of a soldering method, thereby enhancing soldering quality. In particular, when using the high melting point Pb free solder, the soldering apparatus is efficiently operable.

Although a few embodiments of the present invention have been shown and described, it would be appreciated by those skilled in the art that various modifications, additions and substitutions may be made in these embodiments without departing from the principle and spirit of the invention, the scope of which defined in the claims and their equivalents.

What is claimed is:

1. A soldering apparatus, comprising:
a preheating conveyor to convey a printed circuit board with electronic components mounted thereon;
at least one preheating heater to preheat the printed circuit board conveyed by the preheating conveyor;
a soldering conveyor positioned adjacent to the preheating conveyor to convey the printed circuit board preheated by the preheating heater, the soldering conveyor being driven at a different driving speed from a driving speed of the preheating conveyor; and
a soldering unit to solder the electronic components to the printed circuit board conveyed by the soldering conveyor.

2. The soldering apparatus according to claim 1, wherein the driving speed of the preheating conveyor is slower than the driving speed of the soldering conveyor.

3. The soldering apparatus according to claim 2, further comprising:
a cooling conveyor positioned adjacent to the soldering conveyor to convey the printed circuit board soldered by the soldering unit.

4. The soldering apparatus according to claim 3, wherein the driving speed of the cooling conveyor is slower than the driving speed of the soldering conveyor.

5. The soldering apparatus according to claim 4, further comprising:
a first motor to drive the preheating conveyor;
a second motor to drive the soldering conveyor; and
a third motor to drive the cooling conveyor.

6. The soldering apparatus according to claim 2, further comprising:
a cooling fan to cool the printed circuit board conveyed by the cooling conveyor.

7. The soldering apparatus according to claim 2, wherein the soldering unit comprises at least one soldering heater to melt solder cream interposed between the electronic components and the printed circuit board.

8. The soldering apparatus according to claim 7, wherein the preheating heater heats the printed circuit board conveyed on the preheating conveyor to a temperature of about 150 to 180° C.

9. The soldering apparatus according to claim 7, wherein the soldering heater heats the printed circuit board conveyed on the soldering conveyor to a temperature of about 220° C.

10. The soldering apparatus according to claim 7, wherein the at least one soldering heater comprises a plurality of soldering heaters positioned below the soldering conveyor.

11. The soldering apparatus according to claim 7, wherein the at least one preheating heater comprises a plurality of preheating heaters positioned below the preheating conveyor.

12. The soldering apparatus according to claim 2, wherein the soldering unit comprises a solder container to contain a liquid solder, and a nozzle to inject the liquid solder to the printed circuit board with the electronic components mounted thereon.

13. A soldering method, comprising:
preheating a printed circuit board with electronic components mounted thereon while conveying the printed circuit board at a first driving speed;
soldering the electronic components to the printed circuit board while conveying the printed circuit board at a second driving speed; and
cooling the printed circuit board while conveying the printed circuit board at a third driving speed.

14. The soldering method according to claim 13, wherein the first driving speed is slower than the second driving speed.

15. The soldering method according to claim 14, wherein the third driving speed is slower than the second driving speed.

16. A Pb-free soldering apparatus, comprising:
a preheating conveyor to convey a printed circuit board with electronic components mounted thereon;
a preheating heater to preheat the printed circuit board conveyed by the preheating conveyor;
a soldering conveyor positioned adjacent to the preheating conveyor to convey the printed circuit board preheated by the preheating heater;
a soldering unit to solder the electronic components to the printed circuit board conveyed by the soldering conveyor;
a cooling conveyor positioned adjacent to the preheating conveyor to convey the printed circuit board soldered by the soldering unit; and
a cooling fan to cool the printed circuit board conveyed by the cooling conveyor.

17. A soldering apparatus, comprising:
a preheating unit which conveys a printed circuit board with mounted electronic components at a first linear speed and preheats the printed circuit board to a temperature of about 150 to 180° C.;
a soldering unit positioned adjacent to the preheating unit which conveys the preheated printed circuit board at a second linear speed faster than the first linear speed, heats the printed circuit board to about 220° C., and solders the electronic components to the printed circuit board using a lead free solder having a melting point of about 217° C.; and
a cooling unit positioned adjacent the soldering unit which conveys the soldered printed circuit board away from the soldering unit at a third linear speed slower than the second linear speed.

18. The soldering apparatus according to claim 17, wherein the first linear speed is about 600 to 700 mm/min.

19. The soldering apparatus according to claim 18, wherein the second linear speed is about 1,000 to 1,200 mm/min.

20. The soldering apparatus according to claim 17, wherein each of the conveying unit, the soldering unit and the cooling unit comprises a respective conveying surface and the respective conveying surfaces are coplanar.

21. The soldering apparatus according to claim 17, wherein the soldering unit solders the electronic components to the printed circuit board using reflow soldering.

22. The soldering apparatus according to claim 17, wherein the soldering unit solders the electronic components to the printed circuit board using wave soldering.

23. The soldering apparatus according to claim 17, wherein:
the lead free solder is provided in a soldering cream printed on the printed circuit board;
the preheating unit further comprises at least one preheater to preheat the printed circuit board conveyed by the preheating unit; and
the soldering apparatus further comprises at least one air discharger positioned above the preheating unit to discharge a gas generated from the soldering cream during the preheating of the printed circuit board.

24. A method of soldering electronic components to a printed circuit board, the method comprising:
preheating the printed circuit board to a temperature of about 150 to 180° C. while conveying the printed circuit board at a linear speed of about 600-700 mm/min;
soldering the electronic components to the printed circuit board using a lead free solder while conveying the printed circuit board at a linear speed of about 1,000 to 1,200 mm/min; and
cooling the printed circuit board while conveying the printed circuit board at a linear speed of less than about 1,000 to 1,200 mm/min.

25. The method according to claim 24, wherein the lead free solder comprises a Sn—Ag—Cu alloy.

26. The method according to claim 25, wherein the Sn—Ag—Cu alloy has a melting point of about 217° C.

27. The method according to claim 26, further comprising:
heating the printed circuit board to about 220° C. while soldering the electronic components to the printed circuit board.

28. The method according to claim 27, wherein the printed circuit board is maintained at the about 220° C. for about 25 seconds.

29. The method of claim 13, wherein:
where a plurality of printed circuit boards are to be sequentially soldered, the method further comprises spacing the printed circuit boards during the preheating consistent with the second driving speed.
